(19) United States
(12) Patent Application Publication
(10) Pub. No.: US 2026/0170881 A1
(43) Pub. Date: Jun. 18, 2026

(54) DOWNLOADING DATA AT NON-DRIVING SITUATIONS FOR VEHICLE SYSTEMS

(71) Applicant: TOYOTA JIDOSHA KABUSHIKI KAISHA, Aichi-ken (JP)

(72) Inventors: Keisuke SAWADA, Edogawa-ku (JP); Mitsuo Date, Funabashi-shi (JP)

(21) Appl. No.: 18/983,162

(22) Filed: Dec. 16, 2024

(51) Int. Cl. G07C 5/00; G07C 5/08

(52) U.S. Cl. CPC G07C 5/008; G07C 5/0825

(57) ABSTRACT

Downloading data at non-driving situations is performed by receiving, by a mobile computing network in a vehicle, a download request for at least one of an application or a software update; determining whether the vehicle is in a powered-on state or a powered-off state; preventing performance of a download of the download request in response to determining that the vehicle is in the powered-on state; queueing the download request in response to preventing performance of the download request; and performing the download of the download request in response to the vehicle transitioning to the powered-off state.

### BACKGROUND

Modern vehicles are becoming increasingly connected with external systems (e.g.,

cloud servers, traffic management systems, other vehicles, etc.) via wireless technologies like cellular networks, Wi-Fi, and satellite links. In modern connected vehicles, data comes from multiple sources and is used for various purposes, ranging from safety-critical functions to improving the user experience.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for downloading data at non-driving situations, according to at least one embodiment of the subject disclosure.

FIG. 2 is an operational flow for downloading data at non-driving situations, according to at least one embodiment of the subject disclosure.

FIG. 3 is an operational flow for performing downloads of download requests, according to at least one embodiment of the subject disclosure.

FIG. 4 is an operational flow for displaying a user interface, according to at least one embodiment of the subject disclosure.

FIG. 5 is an operational flow for performing downloads of download requests, according to at least one embodiment of the subject disclosure.

FIG. 6 is a block diagram of a hardware configuration for downloading data at non-driving situations, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

When multiple types of data need to be downloaded, performing the downloads at separate occasions enables the most important and time-sensitive data to get delivered in time, which contributes to maintaining safety, functionality, and efficiency. The connectivity between modern vehicles with external servers via wireless technologies allows vehicles to receive real-time information, such as: navigation data (e.g., map data, route search results, surrounding information), traffic condition data (e.g., congestion reports, accident alerts), remote operation data and diagnostics (e.g., key lock/unlock, air conditioner on/off, alarm activation, battery status, vehicle health checks), software updates (e.g., for infotainment systems, safety features, autonomous driving software), weather data (e.g., forecasts for route planning), user-specific data related to vehicle management (e.g., settings for seats, mirrors, climate control, account authentication, database of voice recognition), entertainment data (e.g., music, video, image, web search), as well as emergency related data (e.g., emergency call, security patch). However, downloading multiple types of data at once can strain a vehicle's connectivity and processing resources. When the vehicle is powered on, download of data is increased compared to when the vehicle is powered off. For example, downloads of navigation data, music streaming data, etc., are expected while the vehicle is powered on. The increase of downloads leaves less computational resources for download of application data or software update data. Therefore, performing the downloads at separate occasions is beneficial in enabling important updates to be processed in time, so that the vehicle can remains safely and efficiently operable.

In at least some embodiments described herein, the solution to the above-mentioned problem is allowing users to download data at non-driving situations. That is, download of application data or software update data to a vehicle is performed during a period from power-off (e.g., ignition off) of the vehicle to power-on (e.g., ignition on) of the vehicle. By performing download of application data or software update data to a vehicle while the vehicle is powered off, degradation of communication capability of the vehicle while the vehicle is powered on can be avoided.

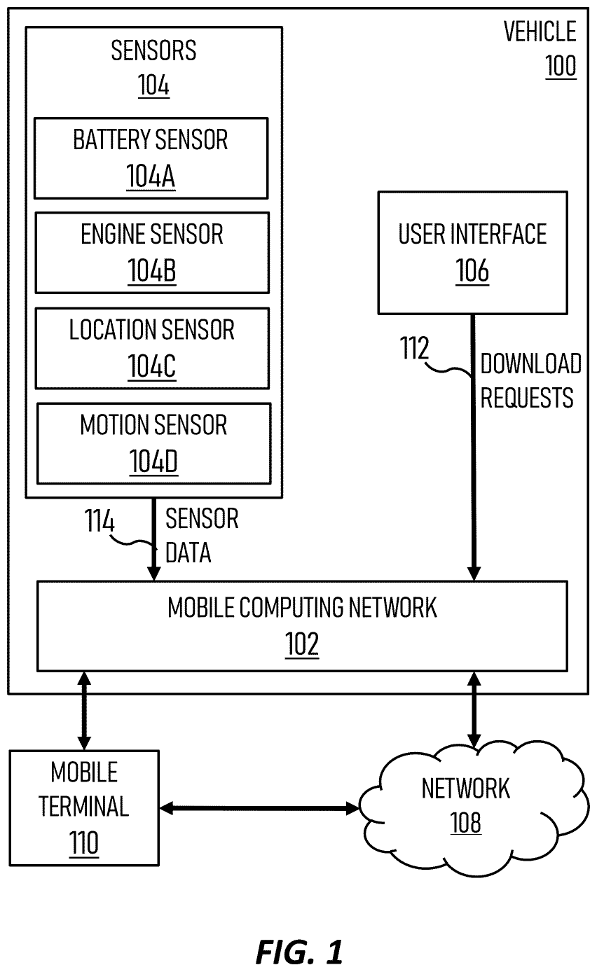

FIG. 1 is a schematic diagram of a system for downloading data at non-driving situations, according to at least one embodiment of the subject disclosure. The system includes a plurality of sensors 104, and a user interface 106 connected to a mobile computing network 102 within a vehicle 100. Vehicle 100 is further in communication with a mobile terminal 110 and a network 108 through mobile computing network 102. Sensors 104 include a battery sensor 104A, an engine sensor 104B, a location sensor 104C and a motion sensor 104D. Sensors 104 are configured to transmit sensor data 114 to mobile computing network 102. Mobile terminal 110 is in communication with network 108. User interface 106 is configured to transmit download requests 112 to mobile computing network 102. In at least some embodiments, mobile computing network 102, sensors 104, and user interface 106 are parts of a single device, such as vehicle 100.

In at least some embodiments, vehicle 100 is configured to transmit notifications and instructions to mobile terminal 110, and to receive an application from mobile terminal 110. In at least some embodiments, vehicle 100 is in communication with mobile terminal 110 through mobile computing network 102. In at least some embodiments, vehicle 100 is in communication with mobile terminal 110 through network 108. In at least some embodiments, vehicle 100 is an automobile or an autonomous vehicle.

In at least some embodiments, mobile computing network 102 is configured to receive download requests 112 from user interface 106, and to receive sensor data 114 from sensors 104. In at least some embodiments, mobile computing network 102 is configured to receive notifications. In at least some embodiments, mobile computing network 102 is an integration of wireless communication technologies and computing systems within vehicle 100 to support a variety of connected services, applications, and functions. In at least some embodiments, mobile computing network 102 is configured to enable vehicle 100 to interact with external systems (e.g., the internet, cloud services, other vehicles, or infrastructure), as well as support on-board systems that enhance the driving experience, safety, navigation, and overall functionality of vehicle 100. In at least some embodiments, mobile computing network 102 is a Controller Area Network (CAN), an Ethernet or a Peripheral Component Interconnect Express (PCIe) network, a Universal Serial Bus (USB) network, or a Local Internet Network (LIN).

Sensors 104 are configured to transmit sensor data 114 to mobile computing network 102. Sensors 104 include battery sensor 104A, engine sensor 104B, location sensor 104C and motion sensor 104D. In at least some embodiments, data types of sensor data 114 provided by battery sensor 104A, engine sensor 104B, location sensor 104C and motion sensor 104D are different. In at least some embodiments, battery sensor 104A is configured to detect a remaining capacity of a vehicle battery. In at least some embodiments, battery sensor 104A is configured to detect whether a charging operation is applied to the vehicle battery. In at least some embodiments, battery sensor 104A is configured to detect whether vehicle 100 is in a power saving mode. In at least some embodiments, engine sensor 104B is configured to detect if vehicle 100 is in a power-on state or a power-off state. In at least some embodiments, location sensor 104C is configured to detect the geographic location of vehicle 100. In at least some embodiments, location sensor 104C is configured to determine a precise position, orientation, and movement of vehicle 100 in real-time. In at least some embodiments, location sensor 104C is a GPS (Global Positioning System), an accelerometer, a gyroscope, a compass, etc. In at least some embodiments, motion sensor 104D is configured to detect a vehicle state of vehicle 100. In at least some embodiments, the vehicle state indicates whether vehicle 100 is running or stopped. In at least some embodiments, motion sensor 104D is configured to detect and measure the movement or acceleration of vehicle 100. In at least some embodiments, motion sensor 104D is configured to measure acceleration, angular velocity, and directional changes of vehicle 100. In at least some embodiments, motion sensor 104D is an accelerometer, a gyroscope, an Inertial Measurement Unit (IMU), a radar sensor, or a camera-based system.

User interface 106 is configured to transmit download requests to mobile computing network 102. In at least some embodiments, user interface 106 is configured to enable drivers, passengers, and other users to interact with the vehicle's various systems, technologies, and features. In at least some embodiments, user interface 106 is configured to receive permission to download application data or software update data of pending download requests which are displayed when vehicle is turned off. In at least some embodiments, when the user allows (app or update) data to be downloaded on a user interface, download of data is started. In at least some embodiments, data will be auto downloaded when the vehicle is turned off. In at least some embodiments, user interface 106 is a touchscreen display, a voice control system, a Heads-Up Display (HUD), a gesture control, a smartphone, or a mobile integration and connectivity system. In at least some embodiments, user interface 106 is external to the vehicle.

In at least some embodiments, network 108 is configured to enable communications between mobile terminal 110 and mobile computing network 102 of vehicle 100. In at least some embodiments, network 108 is configured to connect vehicle 100 with external systems, other vehicles, or the cloud. In at least some embodiments, network 108 is configured to enable real-time data exchange, remote diagnostics, entertainment features, and advanced driver assistance systems (ADAS). In at least some embodiments, network 108 is a wired network, a 4G LTE network, a 5G network, or a Wi-Fi network that allows Vehicle-to-Vehicle (V2V) communication or Vehicle-to-Everything (V2X) communication.

Mobile terminal 110 is configured to communicate with vehicle 100 through mobile computing network 102 or network 108. In at least some embodiments, mobile terminal 110 is configured to receive notifications from vehicle 100. In at least some embodiments, mobile terminal 110 is configured to transmit applications to vehicle 100. In at least some embodiments, mobile terminal 110 is a portable device that is configured to connect to networks and exchange data. In at least some embodiments, mobile terminal 110 is a smartphone, a tablet, a smartwatch, a portable laptop, or smart glasses.

Download requests 112 are transmitted by user interface 106 to mobile computing network 102. In at least some embodiments, download requests 112 include requests for downloading applications or data related to operating system updates, entertainment, navigation, vehicle management, security and emergency, etc. In at least some embodiments, entertainment data includes music data, video data, and image data, etc. In at least some embodiments, navigation data includes map data, route search result data (if route search is performed in a server), surrounding information, and traffic conditions, etc. In least some embodiments, vehicle management data includes key lock/unlock, air conditioner on/off, and alarm activation, etc. In at least some embodiments, security data includes security patches. In at least some embodiments, emergency data includes emergency calls. In at least some embodiments, download requests 112 include requests for downloading applications or data related to web searches, account authentications, and database of voice recognitions, etc.

Sensor data 114 is transmitted by sensors 104 to mobile computing network 102. In at least some embodiments, sensor data 114 includes data of different data types, which are detected by different sensors of sensors 104. In at least some embodiments, the types of data are different depending on the sensor design. In at least some embodiments, sensor data 114 includes vehicle battery status data, vehicle state data, geographic location data, etc.

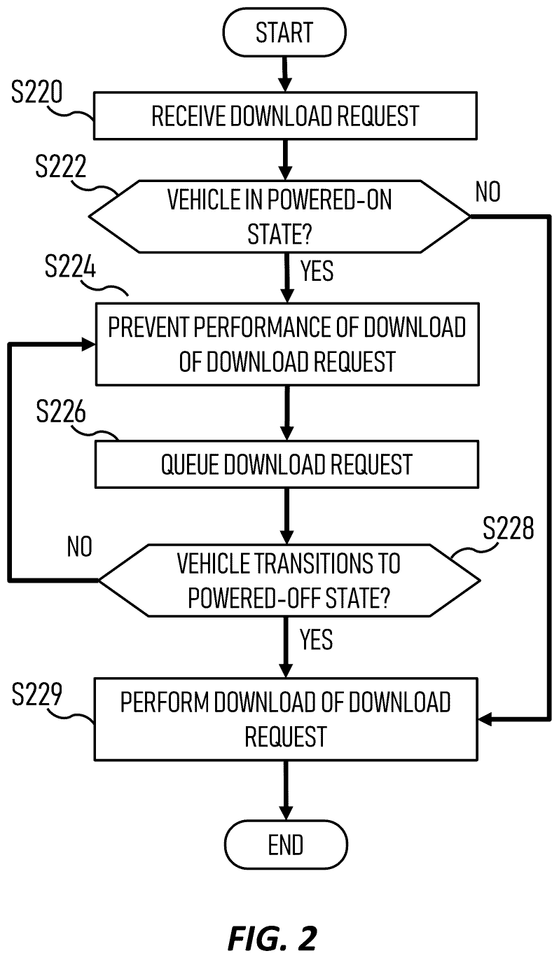

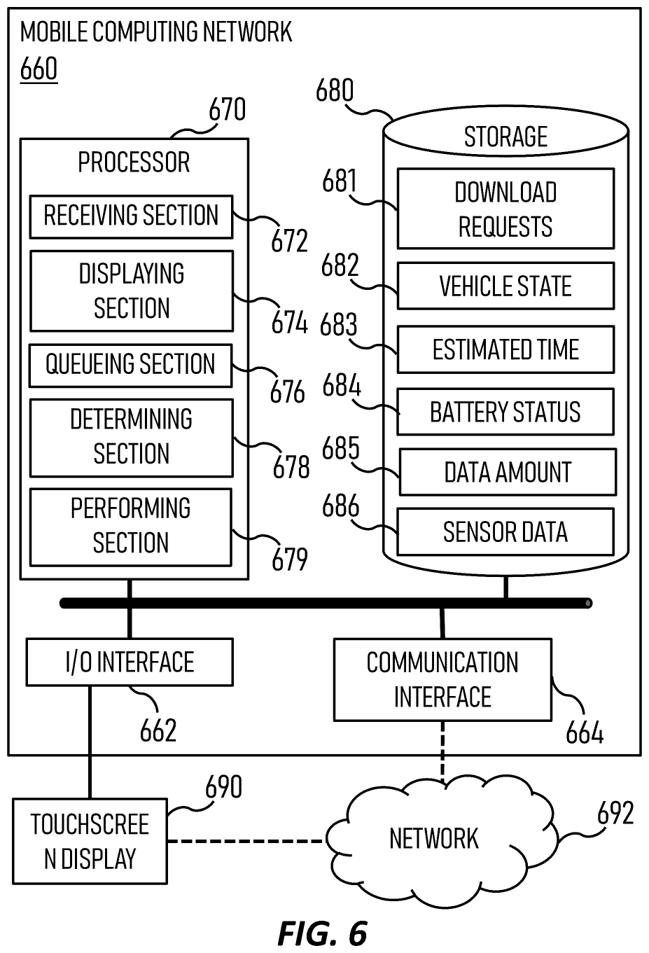

FIG. 2 is an operational flow for downloading data at non-driving situations, according to at least one embodiment of the subject disclosure. The operational flow provides a method of downloading data at non-driving situations. In at least some embodiments, the method is performed by a vehicle, such as vehicle 100 shown in FIG. 1, or a processor of an integrated circuit including sections for performing certain operations, such as the processor 670 shown in FIG. 6, which will be explained hereinafter.

At S220, a receiving section of the processor receives a download request. In at least some embodiments, the receiving section receives, by a mobile computing network in a vehicle, a download request for at least one of an application or a software update. In at least some embodiments, the receiving section receives the download request for downloading applications or data related to operating system updates, entertainment, navigation, vehicle management, security and emergency. In at least some embodiments, the receiving section receives a download request submitted through a user interface.

At S222, the processor or a section thereof determines whether the vehicle is in powered-on state. In at least some embodiments, the processor determines whether the vehicle is in a powered-on state or a powered-off state. In response to the processor determining that the vehicle is in the powered-on state, the operational flow proceeds to preventing performance of download of the download request at S224. In response to the processor determining that the vehicle is not in the powered-on state, the operational flow proceeds to download performance at S229.

At S224, the processor or a section thereof prevents performance of the download of the download request. In at least some embodiments, the processor or the section thereof prevents performance of the download of the download request in response to determining that the vehicle is in the powered-on state. In at least some embodiments, the powered-on state of the vehicle includes an ignition on state of the vehicle.

At S226, a queueing section of the processor queues the download request. In at least some embodiments, the queueing section queues the download request in response to preventing performance of the download request. In at least some embodiments, the queueing section creates a list of queued download requests.

At S228, the processor or a section thereof determines whether the vehicle transitions to powered-off state. In at least some embodiments, the processor or the section thereof determines whether the vehicle has just transitioned to powered-off state. In at least some embodiments, the powered-off state of the vehicle includes an ignition off state of the vehicle. In response to the processor determining that the vehicle has transitioned to the powered-off state, the operational flow proceeds to performing download of the download request at S229. In response to the processor determining that the vehicle has not transitioned to the powered-off state, the operational flow returns to preventing performance of download of the download request at S224.

At S229, a performing section of the processor performs download of the download request. In at least some embodiments, the performing section performs the download of the download request in response to the vehicle transitioning to the powered-off state.

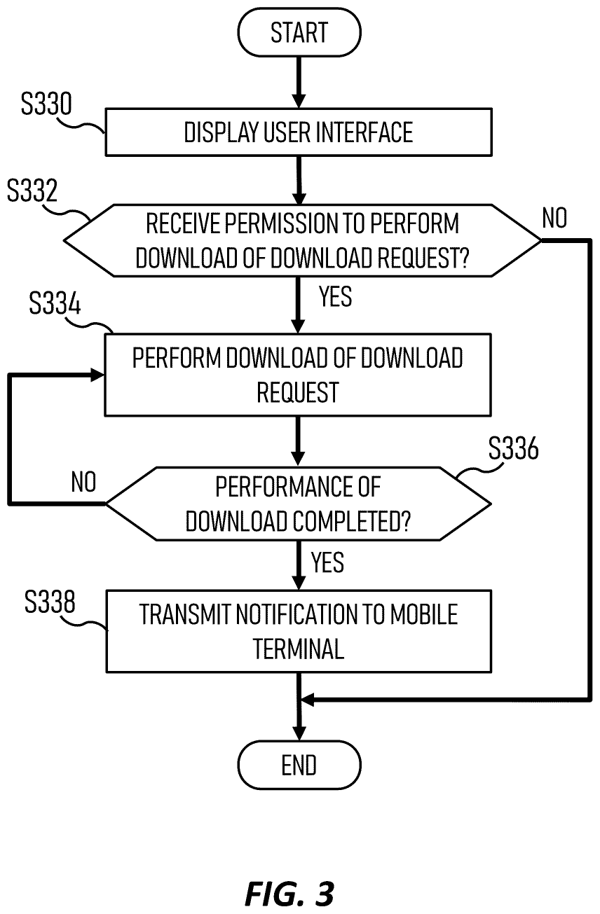

FIG. 3 is an operational flow for performing downloads of download requests, according to at least some embodiments of the subject disclosure. The operation flow provides a method of performing downloads of download requests. In at least some embodiments, the method is performed by a vehicle, such as vehicle 100 shown in FIG. 1, or a processor of an integrated circuit including sections for performing certain operations, such as the processor 670 shown in FIG. 6, which will be explained hereinafter.

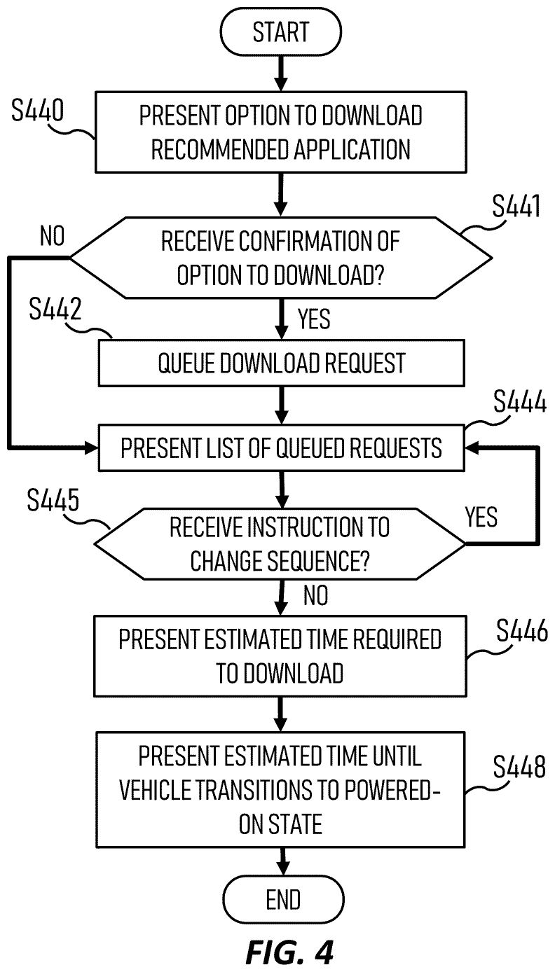

At S330, a displaying section of the processor displays a user interface. In at least some embodiments, the displaying section displays a user interface configured to receive permission to perform the download of the download request in response to the vehicle transitioning to the powered-off state. In at least some embodiments, the determining section performs the operations shown in FIG. 4, which will be explained hereinafter.

At S332, the receiving section determines whether permission to perform download of the download request is received. In at least some embodiments, the receiving section receives, by the mobile computing network, the permission to perform the download of the download request. In at least some embodiments, performing the download of the download request is permitted in response to the vehicle transitioning to the powered-off state. In response to the processor determining that permission is received, the operational flow proceeds to download performance at S334. In response to the processor determining that permission is not received, the operational flow ends.

At S334, the performing section performs download of the download request. In at least some embodiments, the performing section performs the download of the download request further in response to receiving, by the mobile computing network, the permission to perform the download of the download request.

At S336, the processor or a section thereof determines whether performance of download is completed. In at least some embodiments, the processor or a section thereof determines whether performance of the download is completed. In response to the processor determining that the performance of the download is completed, the operational flow proceeds to transmitting notification to the mobile terminal at S338. In response to the processor determining that the performance of the download is not completed, the operational flow returns to performing the download of the download request at S334.

At S338, the processor or a section thereof transmits a notification to the mobile terminal. In at least some embodiments, the processor or a section thereof transmits a notification to a mobile terminal indicating completion of the download in response to completing performance of the download. In at least some embodiments, when a download is completed, an end notification indicating that the download is completed is transmitted to a mobile terminal of the user. In at least some embodiments, the mobile terminal receives the notification from a mobile computing network of the vehicle directly or through a network.

FIG. 4 is an operational flow for displaying a user interface, according to at least one embodiment of the subject disclosure. The operation flow provides a method of displaying a user interface. In at least some embodiments, the method is performed by a vehicle, such as vehicle 100 shown in FIG. 1, or a processor of an integrated circuit including sections for performing certain operations, such as the processor 670 shown in FIG. 6, which will be explained hereinafter.

At S440, the displaying section of the processor presents an option to download recommended applications. In at least some embodiments, the displaying section presents an option to download a recommended application. In at least some embodiments, the displaying section presents an option to download multiple recommended applications. In at least some embodiments, when the vehicle is powered off, the user interface displays a recommended application, and requests permission to download. In at least some embodiments, the recommended application is selected based on the pending application download. In at least some embodiments, the recommended application is similar to the application pending download. In at least some embodiments, the recommended application is based on location, the recommended application is a payment application for parking lot in response to detecting a location near the parking lot.

At S441, the processor or a section thereof determines whether confirmation of option to download is received. In at least some embodiments, the processor or a section thereof determines whether a confirmation of the option to download the recommended application is received. In response to the processor determining that the confirmation of the option to download the recommended application is received, the operational flow proceeds to queueing the download request at S442. In response to the processor determining that the confirmation of the option to download the recommended application is not received, the operational flow proceeds to presenting a list of queued requests at S444.

At S442, a queueing section queues the download request. In at least some embodiments, the queueing section queues a download request of the recommended application in response to receiving a confirmation of the option to download the recommended application. In at least some embodiments, the queueing section adds the recommended application download request to the list of queued download requests.

At S444, the displaying section presents a list of queued requests. In at least some embodiments, the displaying section presents a list of queued download requests. In at least some embodiments, the queueing section creates a list of queued download requests. In at least some embodiments, the sequence of the queued download requests is provided in the list of queued download requests. In at least some embodiments, when the vehicle is powered off, the user interface displays a list of downloads in sequence during the power-off of the vehicle. In at least some embodiments, the user interface displays controls for manipulation of the sequence of download.

At S445, the processor or a section thereof determines whether an instruction to change the sequence is received. In at least some embodiments, the processor or a section thereof determines whether an instruction to change the sequence of the queued download requests is received. In at least some embodiments, the receiving section receives an instruction to change a sequence of the queued download requests. In response to the processor determining that the instruction to change the sequence is received, the operational flow returns to present the list of queued requests at S444. In response to the processor determining that no instruction to change the sequence is received, the operational flow proceeds to presenting estimated time required to download at S446.

At S446, the displaying section presents an estimated time required to download. In at least some embodiments, the displaying section presents an estimated time required to perform the download of the download request. In at least some embodiments, when the user is asked for permission to perform the download, the estimated time required for each pending download is displayed to the user. In at least some embodiments, the estimated time is determined based on file size, internet speed (bandwidth), connection type, network latency, protocol and file format, and device performance.

At S448, the displaying section presents estimate time until vehicle transitions to powered-on state. In at least some embodiments, the displaying section presents an estimated time until the vehicle transitions to a powered-on state. In at least some embodiments, when the user is asked for permission to perform download, an estimated time until power-on of the vehicle is displayed. In at least some embodiments, estimation methods include a past driving history of the vehicle, detection of battery charging before running, etc. In at least some embodiments, the user is allowed to deny permission to download when the estimated download time is longer than the estimated time until power-on.

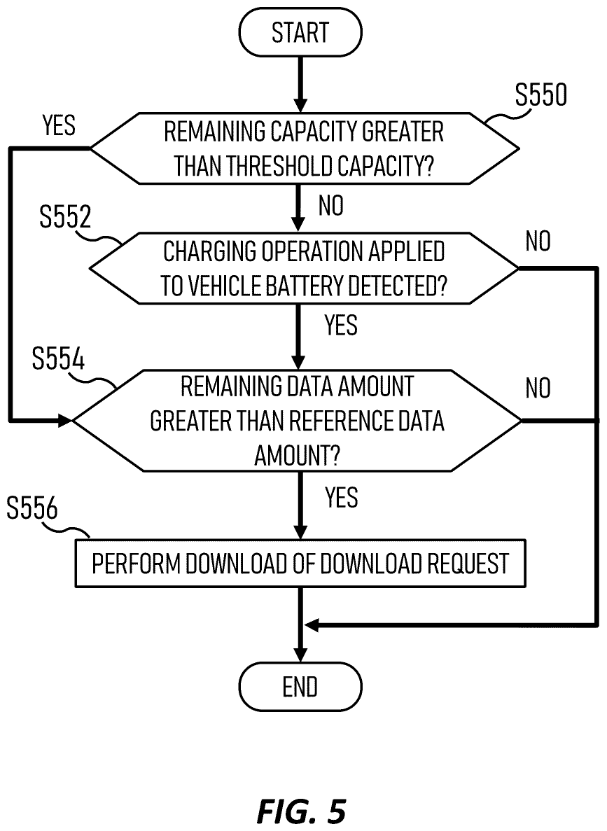

FIG. 5 is an operational flow for performing downloads of download requests, according to at least one embodiment of the subject disclosure. The operation flow provides a method of performing downloads of download requests. In at least some embodiments, the method is performed by a vehicle, such as vehicle 100 shown in FIG. 1, or a processor of an integrated circuit including sections for performing certain operations, such as the processor 670 shown in FIG. 6, which will be explained hereinafter.

At S550, the processor or a section thereof determines whether a remaining capacity is greater than a threshold capacity. In at least some embodiments, the processor or a section thereof determines whether a remaining capacity of the vehicle battery is greater than a threshold capacity. In at least some embodiments, the processor or a section thereof detects the remaining capacity of the vehicle battery. In at least some embodiments, the remaining capacity of the vehicle battery is determined based on sensor data of a battery sensor. In at least some embodiments, when the vehicle is powered off, if a remaining capacity of a battery of the vehicle is equal to or less than a threshold value, downloads are prohibited. In response to the processor determining that the remaining capacity is greater than the threshold capacity, the operational flow proceeds to determining whether remaining data amount is greater than a reference data amount at S554. In response to the processor determining that the remaining capacity is not greater than the threshold capacity, the operational flow proceeds to determining whether a charging operation applied to vehicle battery is detected at S552.

At S552, the processor or a section thereof determines whether charging operation applied to vehicle battery is detected. In at least some embodiments, the processor or a section thereof determines whether a charging operation applied to the vehicle battery is detected. In at least some embodiments, the processor or a section thereof detects a charging operation applied to the vehicle battery after determining that the remaining capacity is not greater than the threshold capacity. In at least some embodiments, when a battery of the vehicle is being charged, download of data is performed regardless of remaining capacity. In at least some embodiments, the user interface enables the user to instruct downloads to proceed once charging is detected. In response to the processor determining that the charging operation applied to vehicle battery is detected, the operational flow proceeds to determining whether remaining data amount is greater than a reference data amount at S554. In response to the processor determining that charging operation applied to vehicle battery is not detected, the operational flow ends.

At S554, the processor or a section thereof determines whether a remaining data amount is greater than a reference data amount. In at least some embodiments, the processor or a section thereof detects a remaining data amount from a mobile carrier network. In at least some embodiments, the reference data amount includes a threshold data amount or a data amount of the download request. In at least some embodiments, the processor or a section thereof determines whether the remaining data amount is greater than a threshold data amount. In at least some embodiments, the processor or a section thereof determines whether the remaining data amount is greater than a data amount of the download request. In at least some embodiments, an upper limit value of communication amount (e.g., mobile carrier network data limit in bytes) during the power-off of the vehicle is set by the user, and when the communication amount during the power-off of the vehicle reaches the upper limit value, download of data is prohibited. In at least some embodiments, the download performance is prohibited if the remaining communication amount is smaller than the size of the download. In response to the processor determining that the remaining data amount is greater than the reference data amount, the operational flow proceeds to performing the download of the download request at S556. In response to the processor determining that the remaining data amount is not greater than the reference data amount, the operational flow ends.

At S556, the performing section performs the download of the download request. In at least some embodiments, the performing section performs the download of the download request further in response to determining that the remaining data amount is greater than a threshold data amount. In at least some embodiments, the performing section performs the download of the download request further in response to determining that the remaining data amount is greater than a data amount of the download request.

FIG. 6 is a block diagram of a hardware configuration for downloading data at non-driving situations, according to at least some embodiments of the subject disclosure.

The exemplary hardware configuration includes mobile computing network 660, which interacts with touchscreen display 690 directly or through network 692. In at least some embodiments, mobile computing network 660 is a network of a computer or other computing device of a vehicle that receives input or commands from touchscreen display 690. In at least some embodiments, mobile computing network 660 is a computer system that executes computer-readable instructions to perform downloads based on priorities.

Mobile computing network 660 includes a processor 670, a storage unit 680, an input/output interface 662, and a communication interface 664. In at least some embodiments, processor 670 is a processor or programmable circuitry executing instructions to cause the processor or programmable circuitry to perform operations according to the instructions. In at least some embodiments, processor 670 includes analog or digital programmable circuitry, or any combination thereof. In at least some embodiments, processor 670 includes physically separated storage or circuitry that interacts through a protocol. In at least some embodiments, storage unit 680 includes a non-volatile computer-readable medium capable of storing executable and non-executable data for access by processor 670 during execution of the instructions. Communication interface 664 transmits and receives data from network 692. Input/output interface 662 connects to various input and output units, such as touchscreen display 690, via a parallel port, a serial port, a keyboard port, a mouse port, a monitor port, a touch screen, a connection with a mobile device and the like to accept commands and present information. In some embodiments, storage unit 680 is external from mobile computing network 660.

Processor 670 includes receiving section 672, displaying section 674, queueing section 676, determining section 678 and performing section 679. Storage unit 680 includes download requests 681, vehicle state 682, estimated time 683, battery status 684, data amount 685 and sensor data 686.

Receiving section 672 is the circuitry or instructions of processor 670 configured to receive download requests. In at least some embodiments, receiving section 672 is configured to receive a download request for at least one of an application or a software update. In at least some embodiments, receiving section 672 is configured to receive permission to perform the download of the download requests. In at least some embodiments, receiving section 672 is configured to receive a confirmation of the option to download the recommended application. In at least some embodiments, receiving section 672 is configured to receive an instruction to change a sequence of the queued download requests. In at least some embodiments, receiving section 672 utilizes information in storage unit 680, such as download requests 681. In at least some embodiments, receiving section 672 includes sub-sections for performing additional functions, as described in the foregoing flow charts. In at least some embodiments, such sub-sections are referred to by a name associated with a corresponding function.

Displaying section 674 is the circuitry or instructions of processor 670 configured to display a user interface. In at least some embodiments, displaying section 674 is configured to present an estimated time required to perform the download of the download request. In at least some embodiments, displaying section 674 is configured to present an estimated time until the vehicle transitions to a powered-on state. In at least some embodiments, displaying section 674 is configured to present an option to download a recommended application. In at least some embodiments, displaying section 674 is configured to present a list of queued download requests. In at least some embodiments, displaying section 674 utilizes information in storage unit 680, such as download requests 681 and vehicle state 682. In at least some embodiments, displaying section 674 includes sub-sections for performing additional functions, as described in the foregoing flow charts. In at least some embodiments, such sub-sections are referred to by a name associated with a corresponding function.

Queueing section 676 is the circuitry or instructions of processor 670 configured to queue download requests. In at least some embodiments, queueing section 676 is configured to queue the download request in response to preventing performance of the download request. In at least some embodiments, queueing section 676 is configured to queue a download request of the recommended application in response to receiving a confirmation of the option to download the recommended application. In at least some embodiments, queueing section 676 utilizes information in storage unit 680, such as download requests 681. In at least some embodiments, queueing section 676 includes sub-sections for performing additional functions, as described in the foregoing flow charts. In at least some embodiments, such sub-sections are referred to by a name associated with a corresponding function.

Determining section 678 is the circuitry or instructions of processor 670 configured to determine vehicle states. In at least some embodiments, determining section 678 is configured to determine whether the vehicle is in a powered-on state or a powered-off state. In at least some embodiments, determining section 678 is configured to determine whether the remaining capacity is greater than a threshold capacity. In at least some embodiments, determining section 678 is configured to determine whether the remaining data amount is greater than a threshold data amount. In at least some embodiments, determining section 678 is configured to determine the remaining data amount is greater than a data amount of the download request. In at least some embodiments, determining section 678 utilizes information in storage unit 680, such as vehicle state 682, battery status 684, data amount 685 and sensor data 686. In at least some embodiments, determining section 678 includes sub-sections for performing additional functions, as described in the foregoing flow charts. In at least some embodiments, such sub-sections are referred to by a name associated with a corresponding function.

Performing section 679 is the circuitry or instructions of processor 670 configured to perform downloads of the download requests. In at least some embodiments, performing section 679 is configured to perform the download of the download request in response to the vehicle transitioning to the powered-off state. In at least some embodiments, performing section 679 is configured to perform the download of the download request further in response to receiving the permission to perform the download of the download request. In at least some embodiments, performing section 679 is configured to perform the download of the download request further in response to determining that the remaining capacity is greater than a threshold capacity. In at least some embodiments, performing section 679 is configured to perform the download of the download request further in response to detecting the charging operation. In at least some embodiments, performing section 679 is configured to perform the download of the download request further in response to determining that the remaining data amount is greater than a threshold data amount. In at least some embodiments, performing section 679 is configured to perform the download of the download request further in response to determining that the remaining data amount is greater than a data amount of the download request. In at least some embodiments, performing section 679 utilizes information in storage unit 680, such as download requests 681, vehicle state 682, estimated time 683, battery status 684, data amount 685 and sensor data 686. In at least some embodiments, performing section 679 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the processor and the storage unit need not be entirely separate devices, but share circuitry or one or more computer-readable mediums in some embodiments. In at least some embodiments, the storage unit includes a hard drive storing both the computer-executable instructions and the data accessed by the processor, and the processor includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a processor responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, downloading data at non-driving situations is performed by receiving, by a mobile computing network in a vehicle, a download request for at least one of an application or a software update; determining whether the vehicle is in a powered-on state or a powered-off state; preventing performance of a download of the download request in response to determining that the vehicle is in the powered-on state; queueing the download request in response to preventing performance of the download request; and performing the download of the download request in response to the vehicle transitioning to the powered-off state.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A method comprising:
receiving, by a mobile computing network in a vehicle, a download request for at least one of an application or a software update;
determining whether the vehicle is in a powered-on state or a powered-off state;
preventing performance of a download of the download request in response to determining that the vehicle is in the powered-on state;
queueing the download request in response to preventing performance of the download request; and
performing the download of the download request in response to the vehicle transitioning to the powered-off state.

2. The method of claim 1, wherein the performing the download of the download request includes displaying a user interface configured to receive permission to perform the download of the download request in response to the vehicle transitioning to the powered-off state,
wherein the performing the download of the download request is further in response to receiving, by the mobile computing network, the permission to perform the download of the download request.

3. The method of claim 2, wherein the displaying the user interface includes presenting an estimated time required to perform the download of the download request.

4. The method of claim 1, wherein the performing the download of the download request includes transmitting a notification to a mobile terminal indicating completion of the download in response to completing performance of the download.

5. The method of claim 2, wherein the displaying the user interface includes presenting an estimated time until the vehicle transitions to a powered-on state.

6. The method of claim 1, further comprising detecting a remaining capacity of a vehicle battery,
wherein the performing the download of the download request is further in response to determining that the remaining capacity is greater than a threshold capacity.

7. The method of claim 1, further comprising detecting a charging operation applied to the vehicle battery after determining that the remaining capacity is not greater than the threshold capacity,
wherein the performing the download of the download request is further in response to detecting the charging operation.

8. The method of claim 2, wherein the displaying the user interface includes presenting an option to download a recommended application; and
queueing a download request of the recommended application in response to receiving a confirmation of the option to download the recommended application.

9. The method of claim 2, wherein the displaying the user interface includes presenting a list of queued download requests.

10. The method of claim 9, wherein the displaying the user interface includes receiving, by the mobile computing network, an instruction to change a sequence of the queued download requests.

11. The method of claim 1, wherein the performing the download of the download request includes detecting a remaining data amount from a mobile carrier network;
wherein the performing the download of the download request is further in response to determining that the remaining data amount is greater than a threshold data amount.

12. The method of claim 1, wherein the performing the download of the download request is further in response to determining that the remaining data amount is greater than a data amount of the download request.

13. A device comprising:
a processor including circuitry configured to
receive, by a mobile computing network in a vehicle, a download request for at least one of an application or a software update;
determine whether the vehicle is in a powered-on state or a powered-off state;
prevent performance of a download of the download request in response to determining that the vehicle is in the powered-on state;
queue the download request in response to preventing performance of the download request; and
perform the download of the download request in response to the vehicle transitioning to the powered-off state.

14. The device of claim 13, wherein the processor performs the download of the download request includes the processor being further configured to display a user interface configured to receive permission to perform the download of the download request in response to the vehicle transitioning to the powered-off state,
wherein the processor performs the download of the download request in response to the processor receives, by the mobile computing network, the permission to perform the download of the download request.

15. The device of claim 14, wherein the processor displays the user interface includes the processor further configured to present an estimated time required to perform the download of the download request.

16. The device of claim 13, wherein the processor performs the download of the download request includes the processor being further configured to transmit a notification to a mobile terminal indicating completion of the download in response to the processor completing performance of the download.

17. A non-transitory computer-readable medium having instructions recorded thereon that are executable by one or more processors to perform operations comprising:
receiving, by a mobile computing network in a vehicle, a download request for at least one of an application or a software update;
determining whether the vehicle is in a powered-on state or a powered-off state;
preventing performance of a download of the download request in response to determining that the vehicle is in the powered-on state;
queueing the download request in response to preventing performance of the download request; and
performing the download of the download request in response to the vehicle transitioning to the powered-off state.

18. The non-transitory computer-readable medium of claim 17, wherein the performing the download of the download request includes displaying a user interface configured to receive permission to perform the download of the download request in response to the vehicle transitioning to the powered-off state,
wherein the performing the download of the download request is further in response to receiving, by the mobile computing network, the permission to perform the download of the download request.

19. The non-transitory computer-readable medium of claim 18, wherein the displaying the user interface includes presenting an estimated time required to perform the download of the download request.

20. The non-transitory computer-readable medium of claim 17, wherein the performing the download of the download request includes transmitting a notification to a mobile terminal indicating completion of the download in response to completing performance of the download.
